(19) United States
(12) Patent Application Publication
(10) Pub. No.: US 2018/0303293 A1
(43) Pub. Date: Oct. 25, 2018

(54) BACK WASBACK WASHING AND MASSAGING DEVICE

(71) Applicant: Donald Bence, Laval (CA)

(72) Inventor: Donald Bence, Laval (CA)

(21) Appl. No.: 15/491,517

(22) Filed: Apr. 19, 2017

(51) Int. Cl. A47K 7/04; A61H 7/00; A61H 15/00; A47K 7/02

(52) U.S. Cl. CPC A47K 7/04; A61H 7/007; A61H 2015/0028; A47K 7/022; A61H 15/0078

(57) ABSTRACT

A combination back washing and massaging device is provided that may be configured to wash, soap, scrub, and massage a user. In some embodiments, the present invention may comprise a central housing having moveable and adjustable washing, scrubbing, and massaging discs that, in certain embodiments, may be controlled by a user via hand-held control elements. Additionally, the present invention may provide for one or more straps and foldable handles, both of which may be configured to secure the present invention to a user's back. In some embodiments, the present invention may also provide for a user to pour soap or other materials into the present invention, which may be dispersed via the discs onto a user's back.

### CROSS-REFERENCE TO RELATED APPLICATION

This application claims priority to U.S. Provisional Application No. ______ filed on ______, 201X, the disclosure of which, including any materials incorporated by reference therein, is incorporated herein by reference in its entirety.

### TECHNICAL FIELD

The present invention relates generally to the field of shower accessories and more specifically relates to a back washing and massaging device.

### BACKGROUND

The human body is amazing in many ways, but its design does have some flaws. Among them is the difficulty many people have with reaching their back. This becomes particularly problematic where cleanliness is concerned, and such difficulty can cause a person's back to be improperly washed, if it gets washed at all. These problems can be compounded over time, and can cause even worse effects among the elderly. Sometimes, a fall in the shower or an injured shoulder can result when such persons stretch to try and wash their backs. Unfortunately, although many persons have turned to back scrubbers, few if any prove suitable.

Back pain or discomfort is also an unfortunate flaw in the human body's design. Many persons spend large sums of money on massages and other therapies aimed at alleviating back pain. In addition to the cost, these therapies necessarily involve at least one masseuse, and as such can at times cause embarrassment. A problem therefore exists as to how to help persons wash and massage their own backs.

Various attempts to solve this problem have been made. One such attempt can be seen with respect to U.S. Patent Application Publication No. 2011/0145986 A1 incorporated by reference in its entirety herein, which generally discloses a back washing backpack device. While this disclosure does provide for a stable device that washes and scrubs a person's back, it fails to adequately provide for massage functionality.

Another attempt can be seen with respect to U.S. Patent Application Publication No. 2009/0241257 A1, incorporated by reference in its entirety herein, which generally discloses a shower-mounted back scrubbing device. While this disclosure does generally provide for a wider approach angle and ideally a more stable source of the scrubbing, it also fails to provide for massage functionality.

Yet another attempt can be seen with respect to U.S. Pat. No. 9,370,281 incorporated by reference in its entirety herein, which generally discloses a hand-held back scrubber. While this disclosure does provide for portability and different scrubbing surfaces, yet again this disclosure fails to provide for a massage functionality.

Various attempts have been made to solve the problems which may be found in the related art but have thus far been unsuccessful. A need exists for a new combination back washing and massaging device to avoid the above-mentioned problems and inadequacies.

### SUMMARY OF THE INVENTION

It is to be understood that in the present disclosure, all embodiments are provided as illustrative and non-limiting representatives of many possible embodiments. In addition, the terms “is,” “can,” “will,” and the like are herein used as synonyms for and interchangeable with terms such as “may,” “may provide for,” and “it is contemplated that the present invention may” and so forth.

The present invention relates to a back washing and massaging device that overcomes the deficiencies of the prior art. It is contemplated that the present invention may provide a backpack-type combination back washing and massaging device that enables users to safely wash, scrub, and massage their backs.

For purposes of summarizing, certain aspects, advantages, and novel features of the present invention are provided herein. It is to be understood that not all such aspects, advantages, or novel features may be provided in any one particular embodiment. Thus, the disclosed subject matter may be embodied or carried out in a manner that achieves or optimizes one aspect, advantage, or novel feature or group of features without achieving all aspects, advantages, or novel features as may be taught or suggested.

In view of the foregoing disadvantages inherent in the known art, the present invention provides a back washing and massaging device. The general purpose of the present invention, which will be described subsequently in greater detail, is to provide a portable, back-mounted device that scrubs, washes, and massages a back using hand-held controls readily available to the user. The features of the invention which are believed to be novel are particularly pointed out and distinctly claimed in the concluding portion of the specification. These and other features, aspects, and advantages of the present invention will become better understood with reference to the following drawings and detailed description.

In one embodiment, the present invention may provide for a back washing and massaging device comprising generally a rectangular and lightweight main housing or portion configured to align with a human back, the main housing having shoulder straps configured to secure the present invention against a user's back, and foldable side handles designed to wrap around a user's waist, the combination of which is contemplated to secure the present invention against the user's back, and also to facilitate easily removing the present invention from the user's back.

The present invention's main housing has at least two sides, one of which is configured to lay flat against a user's back. On this surface, the present invention may provide for one or more removable sponges that may be mounted on two discs having external holes covered, wherein the discs and the sponges may be adjustable along tracks, rails, or other incremental adjustment means. The discs may be configured to perform one or more wash, scrub, massage, kneading motion, rolling motion, soap sprinkling, or other compatible functions. The discs may cause the sponge to rotate, vibrate, contour or otherwise either wash, scrub, massage, or any and all such functions. Underneath the removable sponges, the present invention may also provide for a soap dispensing element that distributes soap through the sponge and onto a user's back, before during or after the removable sponge operates. The soap dispensing element may be attached to one or more tubes that are in turn attached to one or more receptacles within the central housing, the receptacles configured to receive soap or other materials that may be poured through an opening in the central housing's top side, the opening being removably covered by a removable cap.

At the top of the main housing, the present invention may provide for a removable cap that covers an entry port wherein a user may pour soap, powder, or any other bathing or massaging materials. It is contemplated that in some embodiments, the main housing may provide for the machinery, tubing, power source such as a battery, and all such necessary elements to cause the present invention to operate in the manner described herein.

The present invention may also provide that one or more of the foldable and rotatable handles may have one or more controls or remote controls that may operate the present invention. On such controls, the present invention may provide for buttons or other means for controlling rolling motions, kneading motions, on/off, soap dispensing or sprinkling, or other similar functions of the present invention. The present invention's controls may also enable a user to change the angle (up, down, left, right), location, depth, pressure, timing, or other such characteristic of the wash, scrub, massage, or other function of the present invention.

The reverse of the main housing may also provide for a pop out towel rod holder, a battery compartment capable of access by a user, and in some embodiments an exit portal for excess material.

In some embodiments, it is also contemplated that the present invention may fold up into a suitcase-like carrying case shape, having in some embodiments a case handle and a case lock.

To use the present invention, in some embodiments, a user may place the device on the user's back using two straps that go on the user's shoulders to keep the devise stable and steady. The user may pop off the removable cap on top of the present invention and thereby open the entry port, which may resemble a small compartment inside the devise where a user can add liquid soap. The added soap may be drawn from that compartment and propelled into one or more external holes directly through the two removable sponges of the present invention and onto a user's back.

With the help of remotes on each handles, a user may control two functions which are back washing and massage. The left remote may control the massage and the right one may control back washing. On the present invention's massage remote, when turned on, multiple functions such as the kneading motion, rolling motion, and vibration may be operable if a user presses the appropriate button, which if pushed may activates the desired motion. The present invention may also provide for a bar that may control the present invention's speed and/or intensity. The right remote when turned on may control or operate the present invention's washing function. The present invention may also provide for a soap button that when pressed releases soap from the outlet directly through the sponges, and the sponges may also spin in a 360 motion, wherein the contact of water will automatically create bubbles and wash the user's back thoroughly. The present invention may also provide buttons that a user may press to cause the discs and sponges to move left, right, up, or down, which gives the user the chance to reach each part of the user's back. The other remote may also provide for a bar that may similarly control the present invention's speed and/or intensity.

The present invention's shoulder straps and handles may be foldable so as to cause the present invention to fit in a custom carrying case or in any normal size traveling suitcase. Additionally, the present invention may also provide for two pop out hooks on the back that a user may use if the user wishes to hang the present invention on a towel rod.

The unique features of the present invention may provide the following benefits for one or more consumers: it may scrub and wash pores. It also may reduce the risk of injury caused by stretching an arm to reach a user's back. It may also massage a user's back while taking a shower. It may also provide back pain relief and relaxation. Additionally, the present invention may help loosen strained muscles. It may also provide users with a back massage in the privacy of their own home without person to person interaction. It may also reduce disease and generally enable users to be more clean.

### BRIEF DESCRIPTION OF THE DRAWINGS

These and other features, aspects and advantages of the present invention will become better understood with regard to the following description, appended claims, and accompanying figures where:

FIG. 1 shows a perspective view of a back washing and massaging device in accordance with one embodiment of the invention.

FIG. 2 shows a perspective view of a back washing and massaging device in accordance with one embodiment of the invention.

FIG. 3 shows an elevational view of a back washing and massaging device in accordance with one embodiment of the invention.

FIG. 4 shows an elevational view of a back washing and massaging device in accordance with one embodiment of the invention.

FIG. 5 shows an elevational view of a back washing and massaging device in accordance with one embodiment of the invention.

FIG. 6 shows a perspective view of a back washing and massaging device in accordance with one embodiment of the invention.

### DETAILED DESCRIPTION

The present invention overcomes the limitations of the prior art by providing a new and more effective back washing and massaging device.

All dimensions specified in this disclosure are by way of example only and are not intended to be limiting. Further, the proportions shown in these Figures are not necessarily to scale. As will be understood by those with skill in the art with reference to this disclosure, the actual dimensions and proportions of any embodiment or element of an embodiment disclosed in this disclosure will be determined by its intended use.

It is to be understood that the drawings and the associated descriptions are provided to illustrate potential embodiments of the invention and not to limit the scope of the invention. Reference in the specification to “one embodiment” or “an embodiment” is intended to indicate that a particular feature, structure, or characteristic described in connection with the embodiment is included in at least an embodiment of the invention. The appearances of the phrase “in one embodiment” or “an embodiment” in various places in the specification are not necessarily all referring to the same embodiment.

Throughout the drawings, reference numbers are re-used to indicate correspondence between referenced elements. In addition, the first digit of each reference number indicates the figure where the element first appears.

As used in this disclosure, except where the context requires otherwise, the term “comprise” and variations of the term, such as “comprising”, “comprises” and “comprised” are not intended to exclude other additives, components, integers or steps.

In the following description, specific details are given to provide a thorough understanding of the embodiments. However, it will be understood by one of ordinary skill in the art that the embodiments may be practiced without these specific detail. Well known features, elements or techniques may not be shown in detail in order not to obscure the embodiments.

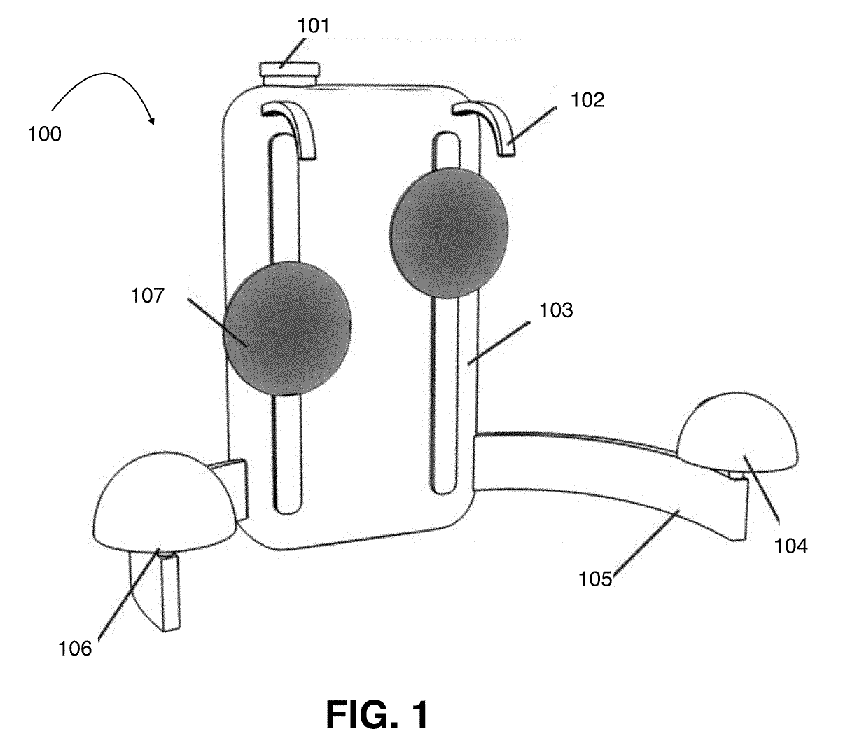

Turning attention to FIG. 1, a perspective view of a back washing and massaging device in accordance with one embodiment of the invention is shown. In the embodiment depicted, the present invention may comprise combination back washing and massaging device 100, removable cap 101, shoulder straps 102, lightweight material 103, left remote 104, foldable handles 105, right remote 106, and removable sponge 107.

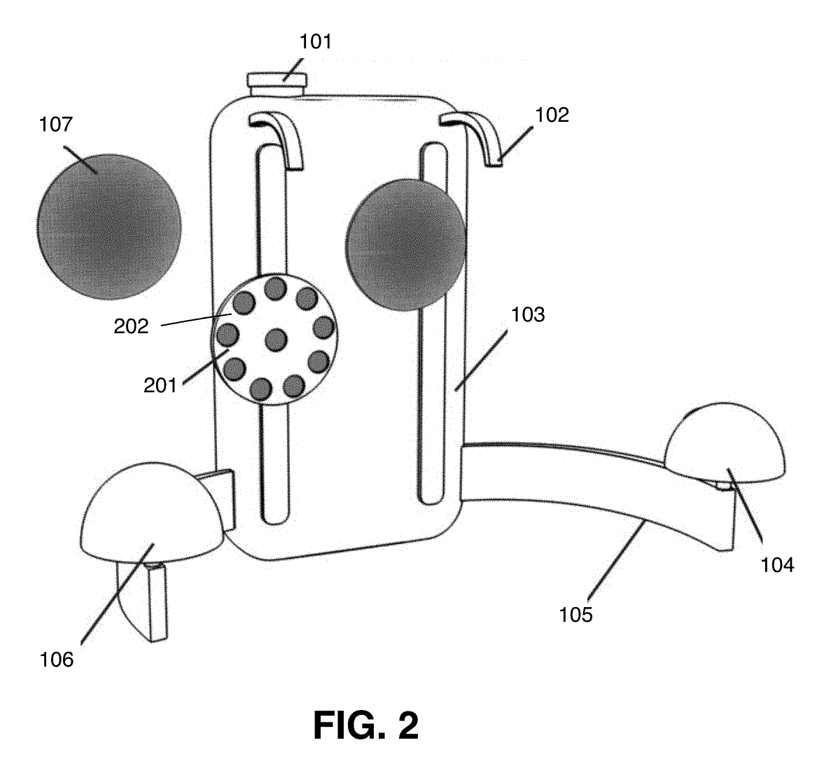

With respect to FIG. 2, a perspective view of a back washing and massaging device in accordance with one embodiment of the invention is shown. In the embodiment depicted, along with the present invention may comprise combination back washing and massaging device 100, removable cap 101, shoulder straps 102, lightweight material 103, left remote 104, foldable handles 105, right remote 106, and removable sponge 107, FIG. 2 also discloses soap outlet 201 and disc 202. In the embodiment depicted, soap outlet 201 is mounted on disc 202, and both soap outlet 201 and disc 202 are covered by removable sponge 107.

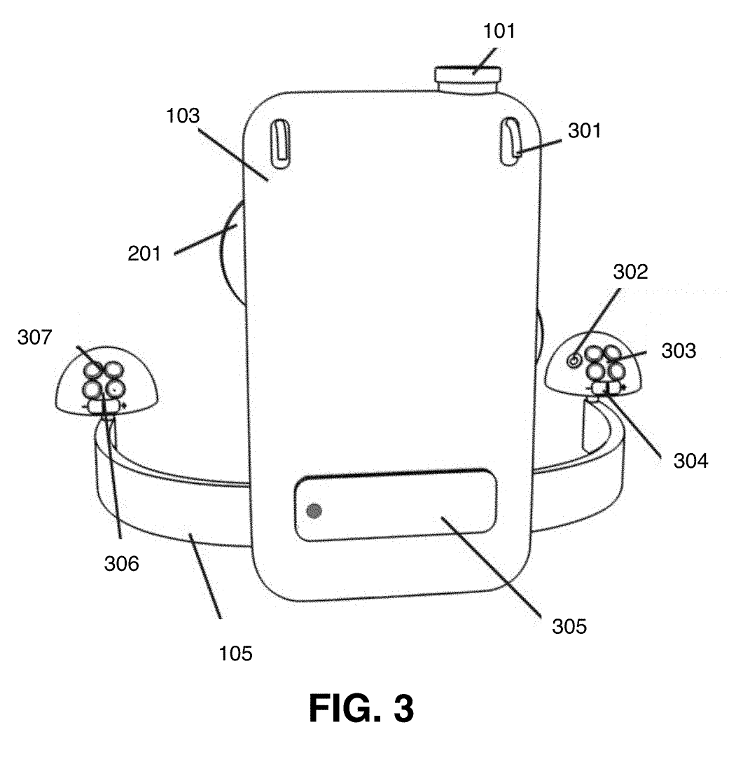

Turning attention to FIG. 3, an elevational view of a back washing and massaging device in accordance with one embodiment of the invention is shown. In the embodiment depicted, the present invention may comprise removable cap 101, lightweight material 103, and foldable handles 105, as well as pop-out towel rod holder 301, on/off button 302, soap sprinkler button 303, remote controls 304, battery compartment 305, kneading motion button 306, and rolling motion button 307.

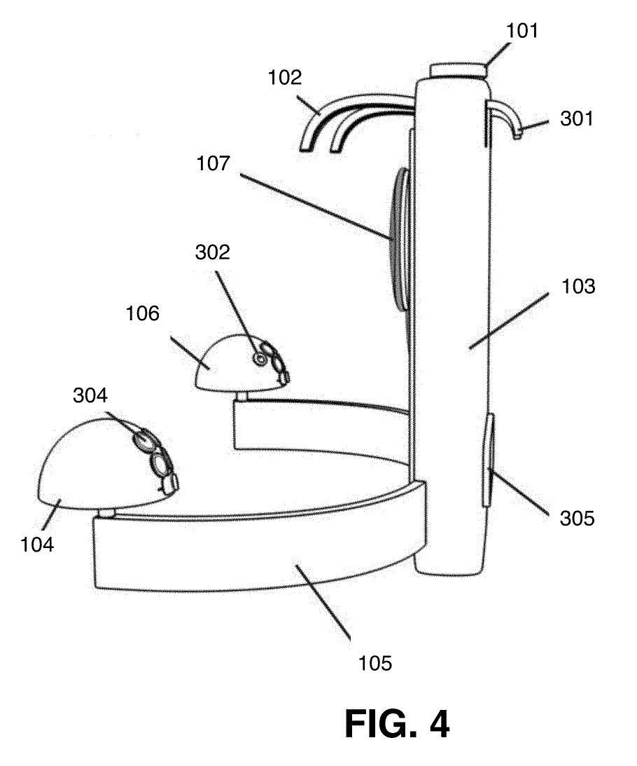

With respect to FIG. 4, an elevational view of a back washing and massaging device in accordance with one embodiment of the invention is shown. In the embodiment depicted, the present invention may comprise removable cap 101, shoulder straps 102, lightweight material 103, left remote 104, foldable handles 105, right remote 106, and removable sponge 107, as well as pop-out towel rod holder 301, on/off button 302, remote controls 304, battery compartment 305, and foldable shoulder straps 401.

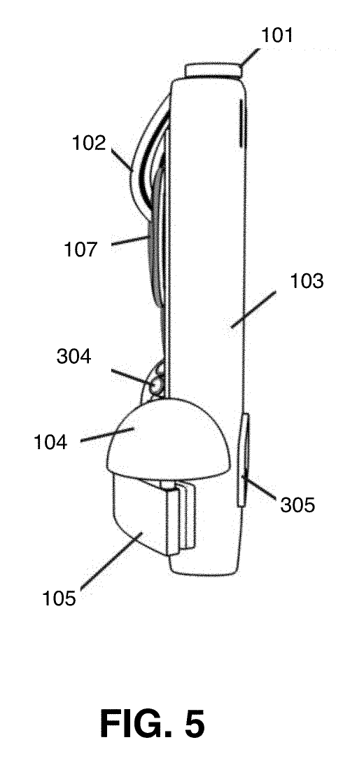

Turning attention to FIG. 5, an elevational view of a back washing and massaging device in accordance with one embodiment of the invention is shown. In the embodiment depicted, the present invention may comprise removable cap 101, shoulder straps 102, lightweight material 103, left remote 104, foldable handles 105, and removable sponge 107, as well as remote controls 304 and battery compartment 305.

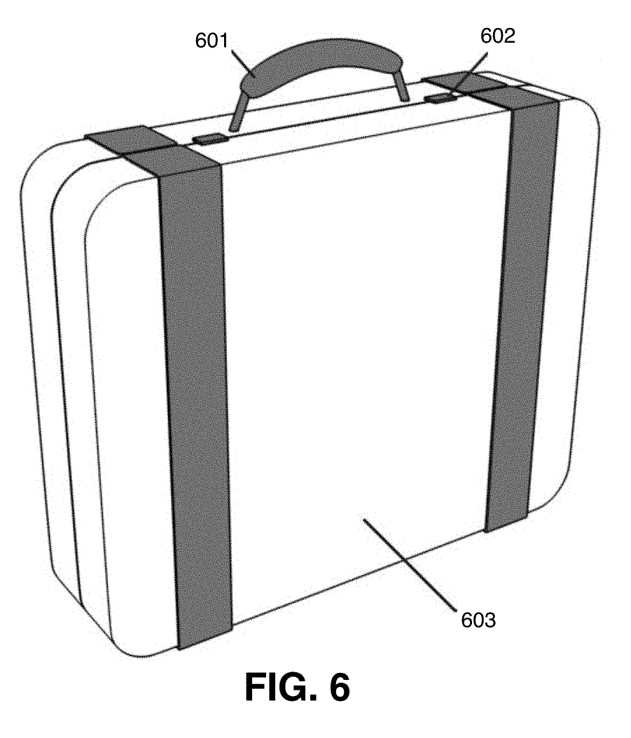

With respect to FIG. 6, a perspective view of a back washing and massaging device in accordance with one embodiment of the invention is shown. In the embodiment depicted, the present invention may comprise case handle 601, case lock 602, and carrying case 603.

### CONCLUSIONS, RAMIFICATIONS, AND SCOPE

Although the present invention has been described with a degree of particularity, it is understood that the present disclosure has been made by way of example and that other versions are possible. As various changes could be made in the above description without departing from the scope of the invention, it is intended that all matter contained in the above description or shown in the accompanying drawings shall be illustrative and not used in a limiting sense. The spirit and scope of the appended claims should not be limited to the description of the preferred versions contained in this disclosure.

All features disclosed in the specification, including the claims, abstracts, and drawings, and all the steps in any method or process disclosed, may be combined in any combination, except combinations where at least some of such features and/or steps are mutually exclusive. Each feature disclosed in the specification, including the claims, abstract, and drawings, can be replaced by alternative features serving the same, equivalent or similar purpose, unless expressly stated otherwise. Thus, unless expressly stated otherwise, each feature disclosed is one example only of a generic series of equivalent or similar features.

Any element in a claim that does not explicitly state “means” for performing a specified function or “step” for performing a specified function should not be interpreted as a “means” or “step” clause as specified in 35 U.S.C. § 112.

While a back washing and massaging device has been disclosed in connection with a number of embodiments shown and described in detail, various modifications should be readily apparent to those of skill in the art.

What is claimed is:

1. A back washing and massaging device, comprising:
a rectangular center member having a front side, a back side, a top side and a bottom side; the front side having at least one track; the at least one disc configured to move along the at least one track; at least one strap fixedly attached to said front side; at least one foldable handle rotatably attached to said front side; the back side having a battery compartment; the battery compartment containing at least one battery connected to an electrical means; the electrical means being within the center member; and the electrical means configured to power the device.

2. The device of claim 1, further comprising a soap dispensing means fixedly mounted on said disc, a receptacle mounted within the center member, a port in the center member's top side, a removable cover configured to removably cover the port, a first tube configured to connect the receptacle and the dispensing means, and a second tube configured to connect the receptacle to the port.

3. The device of claim 1, wherein at least one removable sponge covers the at least one disc.

4. The device of claim 1, wherein the disc is configured to perform a wash function.

5. The device of claim 1, wherein the disc is configured to perform a scrub function.

6. The device of claim 1, wherein the disc is configured to perform a massage function.

7. The device of claim 1, further comprising at least one pop out towel rod holder on the back side.

8. The device of claim 1, further comprising at least one control fixedly connected to the at least one foldable handle, the control configured to influence a function of the device.

9. The device of claim 8, wherein the control directs the one or more discs to perform a wash function.

10. The device of claim 8, wherein the control directs the one or more discs to perform a scrub function.

11. The device of claim 8, wherein the control directs the one or more discs to perform a massage function.

12. The device of claim 8, wherein the control directs the one or more discs to perform a scrub function.

13. The device of claim 8, wherein the control directs the one or more discs to perform a kneading motion function.

14. The device of claim 8, wherein the control directs the one or more discs to perform a rolling motion function.

15. The device of claim 8, wherein the control directs the one or more discs to perform a rolling soap sprinkling function.

16. The device of claim 1, wherein the at least one foldable handle, the at least one strap, and the center member fold into a suitcase shape.

17. The device of claim 1, wherein the center member is made of plastic.

18. The device of claim 1, the top side having a removable cap, the removable cap covering a conduit, the conduit configured to allow materials to enter a receptacle.
